(19) United States
(12) Patent Application Publication
(10) Pub. No.: US 2021/0308849 A1
(43) Pub. Date: Oct. 7, 2021

(54) COMPRESSED-AIR-OPERATED EXPULSION DEVICE

(71) Applicant: PREBENA Wilfried Bornemann GmbH & Co. KG, Schotten (DE)

(72) Inventor: Werner Ruecklinger, Schotten (DE)

(21) Appl. No.: 17/261,045

(22) PCT Filed: Jul. 18, 2019
(86) PCT No.: PCT/EP2019/069439

§ 371 Date: Jan. 18, 2021

(30) Foreign Application Priority Data
Jul. 19, 2018 (DE) 10 2018 117 519.1

(51) Int. Cl. B25C 1/04

(52) U.S. Cl. CPC B25C 1/042; B25C 1/043

(57) ABSTRACT

The invention relates to a pneumatic expulsion device (10) for expelling objects (14) or fluid substances from a reservoir by means of a drive piston (18) which is subjectable to a gas volume compressible in a compression chamber (23), the drive piston (18) being provided with a drive mechanism for compressing the gas volume and with a trigger for expanding the compressed gas volume. The compression chamber (23) is provided with a relief mechanism for temporarily venting the compression chamber (23) and with a filling mechanism (41) for filling the vented compression chamber (23) with compressed air.

The present invention relates to a pneumatic expulsion device for expelling objects or fluid substances from a reservoir by means of a drive piston which can be subjected to a gas volume compressible in a compression chamber, the drive piston being provided with a drive mechanism for compressing the gas volume and with a trigger for expanding the compressed gas volume.

Pneumatic expulsion devices of the kind mentioned above use the gas volume compressed by the upward movement of the drive piston as a gas pressure spring for generating an expelling force acting on the objects to be expelled. An expulsion device of this kind is known from EP 2 243 600 B1, in which the compression chamber is filled with a gas volume which is constant over the lifetime of the expulsion device. Hence, expulsion devices of this kind are filled once during factory assembly with a gas volume that has a filling pressure that is set to the desired expelling force and typically in the range of about 8 bar.

During the alternating compression and decompression processes during operation of the expulsion device, the accompanying temperature changes cause condensate to form in the compressed air stored in the compression chamber because the water vapor contained in the compressed air condenses when the compressed air cools or when the saturation vapor pressure of the compressed air is exceeded due to the compression.

In particular because of corrosion in the compression chamber, which is due to the typically acidic pH of the condensate, the output of the pneumatic expulsion device will drop noticeably after a sufficiently high number of expulsions, refilling of the compression chamber with compressed air, i.e. repair of the expulsion device, being impossible because of the design of the compression chamber. The repair of damage to the device from condensation is just as impossible as the replacement of components of the expulsion device that would require the compression chamber to be opened, such as replacing the expulsion plunger which is connected to the drive piston and which is subject to particularly high wear because it is in direct contact with the objects to be expelled.

Therefore, the object of the present invention is to propose a pneumatic expulsion device that has a comparatively higher lifetime and in particular allows the expulsion device to be repaired by accessing the compression chamber.

To attain said object, the expulsion device according to the invention has the features of claim 1.

In the expulsion device according to the invention, the compression chamber is provided with a relief mechanism for temporarily venting the compression chamber and with a filling mechanism for filling the vented compression chamber with compressed air.

Since the compression chamber is equipped with a relief mechanism and a filling mechanism, the user can empty the compression chamber and refill it with compressed air at a time of their choosing. This means that the compressed air volume contained in the compression chamber can be replaced as a function of a defined number of expulsions, for example, in order to dispose of a condensate having formed in the compression chamber through the relief mechanism.

Since the compressed air contained in the compression chamber can be easily replaced during the life cycle of the expulsion device owing to the design of the expulsion device according to the invention, repairs that require access to the compression chamber, such as replacement of the expulsion plunger connected to the drive piston or replacement of the drive piston itself, can be performed on the expulsion device. The expulsion device can be easily put into operation again because the compression chamber can be refilled with compressed air by means of the filling mechanism after repair or replacement of components of the device.

Preferably, the compression mechanism or the filling mechanism is provided with a pressure gauge which allows the operator to stop the filling process when the desired filling pressure in the compression chamber is displayed. Also, the compression chamber can be provided with a preferably settable pressure relief valve for stopping the filling process.

The compression chamber of the expulsion device can be refilled with compressed air particularly easily if the filling mechanism has a connection mechanism which is connected to the compression chamber and which serves to be connected to a compressed air source, in particular a device-independent compressed air source. In particular, a compressed air source of this kind may be a net connection for connecting the compression chamber of the expulsion device to a net-dependent compressed air source, or a connection mechanism that allows connection to a mobile compressor.

It has proven particularly advantageous for the compressed air source to be a replaceable compressed air cylinder connected to the connection mechanism because this allows net-independent filling of the compression chamber with compressed air without having to provide an air compressor. Instead, a compressed air cylinder can be used, which can be easily carried by the user during use of the expulsion device, making the logistics of enabling refilling of the compression chamber of the expulsion device simple.

If the connection mechanism has a pressure reducer and, in particular, if a compressed air cylinder is used as a compressed air source, the compressed air cylinder for filling the compression chamber can be filled with high filling pressure, allowing it to be particularly small and thus easy to carry.

It is particularly advantageous for the drive mechanism to have a rotation drive member which is engaged with a linear drive member, which is an expulsion plunger, acts on the drive piston, and is accommodated in a linear guide, the drive mechanism being detachably connected to a cylinder unit, which forms the compression chamber, via a piston stopper.

In this specific embodiment of the invention, not only can the compression chamber be opened for repair purposes and can be put into operation again after closing of the compression chamber. Instead, a component of the expulsion device, namely the piston stopper, can serve not only as a stop for the expulsion piston as per its original purpose but also as a connection mechanism between the linear guide and the compression chamber.

Hereinafter, a preferred embodiment of the invention will be explained in more detail with reference to the drawing.

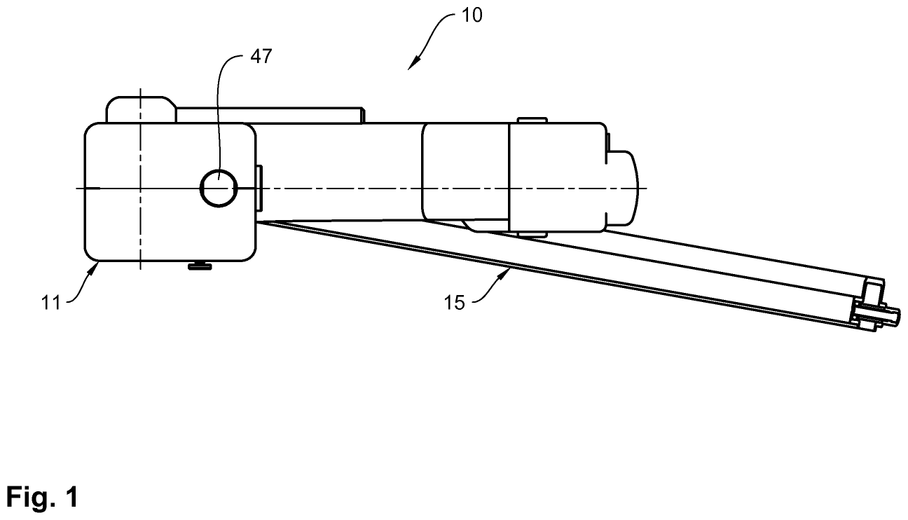

FIG. 1 is a top view of an expulsion device;

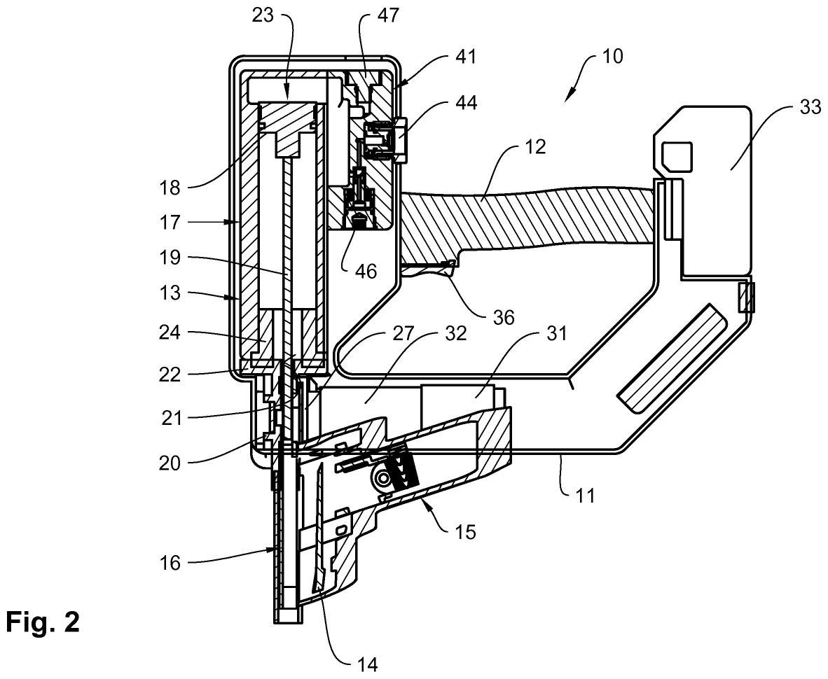

FIG. 2 is a sectional side view of the expulsion device illustrated in FIG. 1;

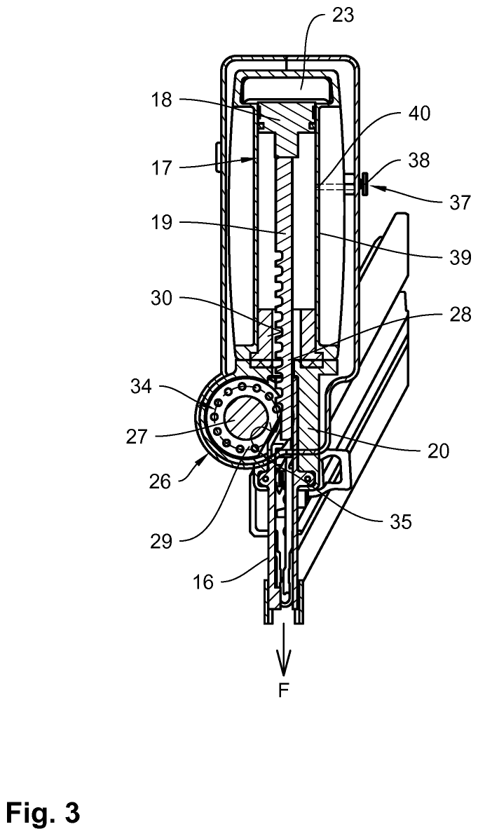

FIG. 3 is a sectional front view of the expulsion device illustrated in FIG. 1;

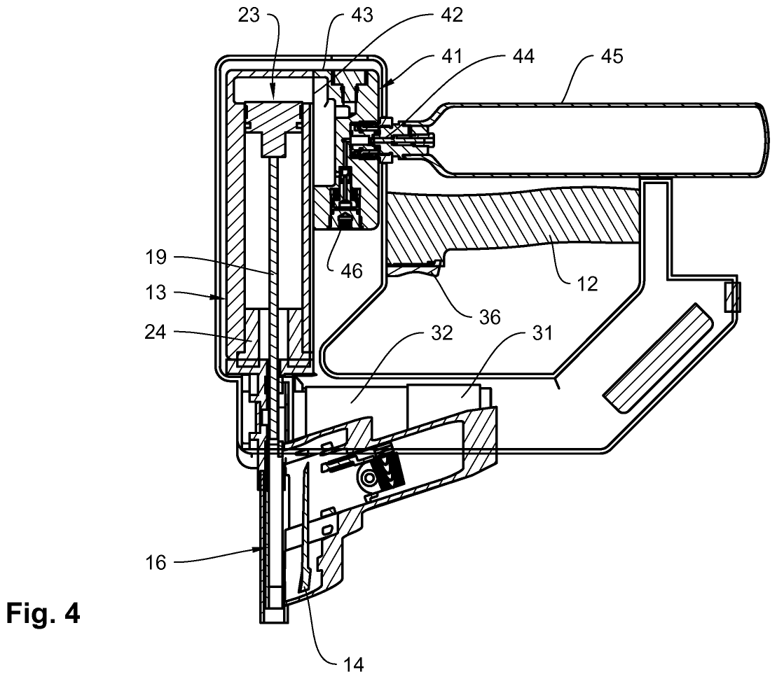

FIG. 4 is an illustration corresponding to FIG. 2 and shows the expulsion device with a compressed air cylinder connected to a filling valve.

FIGS. 1 and 2 show an expulsion device 10 which has, as substantial components, an expulsion unit 13 and a clip 15, which serves as a reservoir for objects 14 to be expelled and which is connected to an expulsion nozzle 16 of expulsion unit 13, on a frame 11, which also serves as a support structure in this case and which is provided with a grip 12.

Expulsion unit 13 has a drive piston 18 which is disposed in a cylinder unit 17 and which is provided with an expulsion plunger 19 guided on a linear guide 20 which simultaneously forms a cylinder bottom 22 of cylinder unit 17, cylinder bottom 22 being provided with a plunger opening 21.

A piston stopper 24 forming a lower stop position of drive piston 18, which is illustrated in its top dead center position in FIG. 2, serves to connect linear guide 20 with a part of cylinder unit 17 that forms a compression chamber 23.

As illustrated in FIG. 3, in particular, a drive mechanism 26 is connected to linear guide 20 of expulsion unit 13, said drive mechanism 26 comprising a rotation drive member 27 and a linear drive member 28 and serving to pre-load drive piston 18 against the air volume compressed by displacement of drive piston 18 to top dead center illustrated in FIGS. 2 and 3. As shown in FIG. 3, in the illustrated embodiment, linear drive member 28 is formed by a lower part of expulsion plunger 19 which is engaged with rotation drive member 27 when drive piston 18 is being moved upward. To this end, rotation drive member 27 has drivers, which are realized as pins 29 and which interact with teeth 30 formed on linear drive member 28. Rotation drive member 27 is driven via an intermediate gearing 32 driven by an electric motor 31, as illustrated in FIG. 2, a battery 33 being provided for supplying electric motor 31 with energy.

As shown in FIG. 3, not all of pitch circle 34 of rotation drive member 27 is provided with pins 29; instead, rotation drive member 27 has a section 35 at its pitch circle 34 along which there is no engagement between pins 29 and teeth 30 of linear drive member 28 during a counterclockwise rotation. During this non-engagement, drive piston 18 can move downward from top dead center until it abuts against piston stopper 24, the accompanying decompression of the compressed air volume located above drive piston 18 in compression chamber 23 causing drive piston 18 to accelerate downward and to exert a corresponding expulsion force F on an object 14 disposed in expulsion nozzle 16 via expulsion plunger 19.

For triggering the expulsion in a defined manner, expulsion device 10 has a trigger 36 (FIG. 2) on grip 12, trigger 36 interacting with a latch (not shown in FIG. 2) which blocks the path of expulsion plunger 19 from the position illustrated in FIG. 3 downward until trigger 36 is actuated.

As shown in FIG. 3, compression chamber 23 is provided with a relief mechanism 37 which, in the case at hand, can be manually actuated via a valve mechanism 38 and opens a venting opening 40 formed in a chamber wall 39 of compression chamber 23 for venting the compressed air from compression chamber 23. For refilling compression chamber 23 with compressed air in such a manner that compression chamber 23 is filled with compressed air of defined pressure, which will be increased to expulsion air pressure higher than the filling air pressure by returning drive piston 18 to top dead center, a filling mechanism 41, which is shown in FIG. 4, in particular, is connected to compression chamber 23.

Filling mechanism 41 has a connection mechanism 43 which is connected to compression chamber 23 via a filling opening 42 and to which a replaceable compressed air cylinder 45 can be connected via a filling valve 44. Compression chamber 23 is provided with a pressure gauge 47 for monitoring the filling pressure in compression chamber 23.

In the case at hand, connection mechanism 43 is provided with a pressure reducer 46, allowing compressed air cylinder 45, which preferably has a filling pressure of 300 bar, to be connected via filling valve 44, and pressure reducer 46, which is preferably sellable, allowing a filling pressure of about 23 bar suitable for filling compression chamber 23 to be set.

As can be seen from a comparison of FIGS. 2 and 4, in the case at hand, expulsion device 10 or, more precisely, housing 11 of expulsion device 10 is configured in such a manner that a use of expulsion device 10 that depends on battery 33 being connected to electric motor 31 is possible only when no compressed air cylinder 45 for refilling compression chamber 23 is connected to filling valve 44 because the space needed to place battery 33 on housing 11 is blocked by compressed air cylinder 45.

1. A pneumatic expulsion device (10) for expelling objects (14) or fluid substances from a reservoir by means of a drive piston (18) which is subjectable to a gas volume compressible in a compression chamber (23), the drive piston (18) being provided with a drive mechanism (26) for compressing the gas volume and with a trigger for expanding the compressed gas volume,
characterized in that the compression chamber (23) is provided with a relief mechanism (37) for temporarily venting the compression chamber (23) and with a filling mechanism (41) for filling the vented compression chamber (23) with compressed air.

2. The pneumatic expulsion device according to claim 1, characterized in that the filling mechanism (41) has a connecting device (43) which is connected to the compression chamber (23) and which serves to be connected to a compressed air source.

3. The pneumatic expulsion device according to claim 2, characterized in that the compressed air source is a replaceable compressed air cylinder (45) which is connected to the connection mechanism (43).

4. The pneumatic expulsion device according to claim 2, characterized in that the connection mechanism (43) has a pressure reducer (46).

5. The pneumatic expulsion device according to claim 1,
characterized in that the drive mechanism (26) has a rotation drive member (27) which is engaged to a linear drive member (28) which is an expulsion plunger (19), acts on the drive piston (18), and is accommodated in a linear guide (20), the drive mechanism (26) being detachably connected to a cylinder unit (17), which forms the compression chamber (23), via a piston stopper (24).
